(19) United States
(12) Patent Application Publication
(10) Pub. No.: US 2006/0161403 A1
(43) Pub. Date: Jul. 20, 2006

(54) Method and system for analyzing data and creating predictive models

(76) Inventors: Eric P. Jiang, San Diego, CA (US); Jie Wei, San Diego, CA (US); Andrew John Caffrey, San Diego, CA (US); Karen Christiana Joiner-Congleton, San Diego, CA (US); Yong M. Kim, San Diego, CA (US); Bradley Steele Paye, San Diego, CA (US); Ryan Duane Persichilli, Chula Vista, CA (US)

Correspondence Address: Marc A. Hubbard;Munsch Hardt Kopf & Harr, P. C., 4000 Fountain Place, 1445 Ross Avenue, Dallas, TX, 75202-2790, US

(21) Appl. No.: 10/733,178

(22) Filed: Dec. 10, 2003

Related U.S. Application Data
(60) Provisional application No. 60/432,631, filed on Dec. 10, 2002.

(51) Int. Cl. G06F 17/10

(52) U.S. Cl. 703/2

(57) ABSTRACT

A method and system of automatically analyzing data, cleansing and normalizing the data, identifying categorical variables within the data set, eliminating co-linearities among the variables and automatically building a statistical model is provided.

### RELATED APPLICATIONS

This application claims the benefit of priority under 35 U.S.C. § 119(e) to U.S. provisional application Ser. No. 60/432,631, filed Dec. 10, 2002, entitled “Method and System for Analyzing Data and Creating Predictive Models,” the entirety of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The invention relates to the field of statistical data analysis and, more particularly, to a method and system for automatically analyzing data and creating a statistical model for solving a problem or query of interest with minimal human intervention.

2. Description of the Related Art

The age of analytics is upon us. Businesses scramble to leverage knowledge culled from customer, enterprise, and third-party data for more effective decision-making and strategic planning. Somewhere, perhaps only in the minds of forward looking executives and managers, resides a corporate Shangri-la, a place where customer and enterprise data fuse seamlessly and transparently with advanced analytical software to provide a stream of clear and reliable business intelligence.

Unfortunately, those who labor in search of this nirvana often find the path fraught with difficulty. Advanced analytical software typically requires extensive training and/or advanced statistical knowledge and the statistical model building process can be a lengthy and complex one, including such difficulties as data cleansing and preparation, handling missing values, extracting useful features from large data sets, and translating model outputs into business knowledge. All told, solutions typically require either expensive payroll increases associated with hiring in-house experts or costly consulting engagements.

Depending on the scope, modeling projects can cost anywhere from $25,000 to $100,000, or more, and take weeks or even months to complete. Some of the tasks involved in building a statistical model based on a large data set include the following steps:

Identify Target Variable: The analyst must select or, in many cases create, the target variable, which relates to the question that is being addressed. For example, the target variable in a credit screening application might involve whether a loan was repaid or not.

Data Exploration: The analyst examines the data, computing and analyzing various summary statistics regarding the different variables contained in the data set. This exploratory analysis is undertaken to identify the most useful predictors, spot potential problems that might be caused by outliers or missing values, and determine whether any of the data fields need to be rescaled or transformed.

Split Data Set: The analyst may randomly split the data into two sets, one of which will be used to build, or train, the model, and the other of which will be used to test the quality of the model once it is built.

Categorical Variable Preprocessing: Categorical variables are variables such as gender and marital status that possess no natural numerical order. These variables must be identified and handled differently than continuous numerical variables such as age and income.

Data Cleansing: The data must be cleansed of missing values and outliers. Missing values are, quite literally, missing data. Outliers are “unusual” data that may skew the results of calculations.

Variable Reduction: Often there is a preference for parsimonious models, and a variety of methods may be employed to attempt to find the most useful predictors within a potentially large set of possible predictors.

Variable Standardization: After variable reduction, the remaining variables are often re-scaled so that a model based on these variables is not unduly biased by only a few variables.

Create Model: Determining the coefficients of variables that best describe the correlation between the target variable and the training data.

Model Selection: Several competing models may be considered.

Model Validation: Run the model using the test data taken from the original data set. This provides a measure of model accuracy that guards against over-fitting by presenting the model with new cases not used during the model-build stage.

In conventional methods and systems, the above steps are performed manually and require the expertise not only of one or more trained analysts, but software programmers as well, and significant time to complete the analysis and processing of the data. In many cases, there are too many variables in the data set, which makes it difficult for an untrained user to analyze and process the data. One particularly difficult task, for example, is deciding which variables should be included in creating a statistical model for a given target variable and which variables should be excluded.

Thus, there is a need for a method and system that can automatically perform such tasks as data cleansing and preparation, handling missing values, identifying and extracting useful features from large data sets, and translating model outputs into business knowledge, with minimal human intervention and without the need for highly trained statisticians to analyze the data. There is a further need for a method and system that can automatically analyze data, and make decisions as to whether the data is, for example, continuous, categorical, highly predictive, or redundant. Such a method and system should also determine for an untrained user which variables in a given data should be used to create a statistical model for solving a particular problem or query of interest. Additionally, there is need for a method and system that can automatically and efficiently build a statistical model based on the selected variables and, thereafter, validate the model.

### BRIEF SUMMARY OF THE INVENTION

The present invention addresses the above and other needs by providing a method and system that automatically performs many or all of the steps described above in order to minimize the difficulty, time and expense associated with current methods of statistical analysis. Thus, the invention provides an automated data modeling and analytical process through which decision-makers at all levels can use advanced analytics to guide their critical business decisions. In addition to being highly automated and efficient, the method and system of the invention provides a reliable and robust general-purpose data modeling solution.

In one embodiment, the invention provides easy-to-use software tools that enable business professionals to build and implement powerful predictive models directly from their desktop computers, and apply statistical analytics to a much broader range of business and organizational tasks than previously possible. Since these software tools automate much of the analytical and modeling processes, users with little or no statistical experience can perform statistical analysis more quickly and easily.

In a further embodiment, the method and system of the invention automatically handles data exploration and preprocessing, which typically takes 50 to 80 percent of an analyst's time during conventional modeling processes.

In a further embodiment, the method and system of the invention scans an entire data set and performs the following tasks: automatically distinguishes between continuous and categorical variables; automatically handles problem data, such as missing values and outliers; automatically partitions the data into random test and train subsets, to protect against sample bias in the data; automatically examines the relationship between each potential variable to find the most promising predictor variables; automatically uses these variables to build an optimal statistical model for a given target variable; and automatically evaluates the accuracy of the models it creates.

In another embodiment, variables in a data set are automatically classified as categorical or continuous. In a further embodiment, categorical variables that exhibit high co-linearity with one or more continuous variables are automatically identified and discarded. In a further embodiment, categories within a variable that are not significantly predictive of the target variable are collapsed with adjacent categories so as to reduce the number of categories in the variable and reduce the amount of data that must be considered and processed to create a statistical model.

In another embodiment, a subset of variables in a data set having a significant predictive value for a given problem or target variable are automatically identified and selected. Thereafter, only those selected variables and the target variable are used to create a statistical model for a problem or query of interest.

In another embodiment, variables having strong co-linearities or correlation with other variables are automatically identified and eliminated so as to remove statistically redundant variables when building the model. In one embodiment, only non-redundant variables having the highest predictive value (e.g., co-linearity or correlation) with the target variable are retained in order to create the statistical model.

In a further embodiment, the method and system of the present invention can use univariate analysis, multivariate analysis and/or Principle Component Analytics (PCA) to select variables and build a model. Since multivariate analysis typically requires greater processing time and system resources (e.g., memory) than univariate analysis, in one embodiment, univariate analysis is used to filter out those variables that have weak predictive value or correlation with the target variable.

In another embodiment, categorical variables contained in the data set are expanded into dummy variables and added to the design matrix along with continuous variables. Since potential co-linearities exist among these variables, whenever there is any pair of variables having a correlation greater than a threshold, the variable that has a weaker correlation with the target variable is dropped as a redundant variable. In one embodiment, if a categorical variable is highly correlated with any continuous one, the categorical variable is discarded. In this embodiment, the categorical variables are dropped rather than continuous variables because categorical variables are expanded into multiple dummy variables, which require greater processing time and system resources when building the statistical model.

In a further embodiment, when building a model, principle components are created and used instead of directly using the variables. As known in the art, principle components are linear combinations of variables and possess two main properties: (1) all components are orthogonal to each other, which means no co-linearities exist among the components; and (2) components are sorted by how much variance of the data set they capture. Therefore, only important components (e.g., those exhibiting a significant level of variance) can be used to create a model. Empirical experiments show that including components, which represent 90% of the variance of a given data set, provides a sufficiently robust and accurate data model. In one embodiment, the number of these components to be included in creating the model can be less then n×0.9 (where n is the number of all principle components). In this way, the size of the design matrix and processing time to build the model can be reduced. In a further embodiment, after the model is built based on the selected principle components, the coefficients of principle components are mapped back to the original variables of the data set to facilitate model interpretation and model deployment.

Thus, the method and system of the invention provides the ability to automatically analyze and process large data sets and create statistical models with minimal human intervention. As a result, users with minimal statistical training can build and deploy successful models with unprecedented ease.

### BRIEF DESCRIPTION OF THE DRAWINGS

FIG. 1 illustrates a data matrix diagram representative of a data set containing a plurality of predictive variables and a target variable.

FIG. 2 illustrates a flow chart diagram that provides a general overview of a process for automatically analyzing data and building a statistical data model, in accordance with one embodiment of the invention.

FIG. 3 illustrates a flow chart diagram of a process of identifying and flagging categorical variables, in accordance with one embodiment of the invention.

FIG. 4 illustrates a flow chart diagram of a process of performing automatic data analysis for model building, in accordance with one embodiment of the invention.

FIG. 5 illustrates a flow chart diagram of a process of determining a best model construction path, in accordance with one embodiment of the invention.

FIG. 6 illustrates a flow chart diagram of pre-processing continuous variables in a deployment data set, in accordance with one embodiment of the invention.

FIG. 7 illustrates a flow chart diagram of pre-processing categorical variables in a deployment data set, in accordance with one embodiment of the invention.

### DETAILED DESCRIPTION OF THE PREFERRED EMBODIMENTS

The invention is described in detail below with reference to the figures wherein like elements are referenced with like numerals throughout.

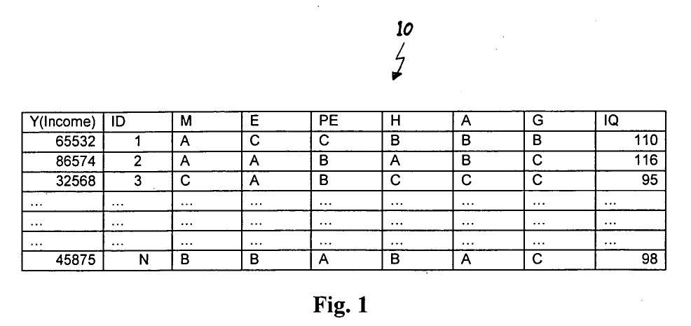

As used herein, the term “data” or “data set” refers to information comprising a group of observations or records of one or more variables, parameters or predictors (collectively and interchangeably referred to herein as “variables”), wherein each variable has a plurality of entries or values. A “target variable” refers to a variable having a range or a plurality of possible outcomes, values or solutions for a given problem or query of interest. For example, as shown in FIG. 1, a data set 10 may include the following seven exemplary predictor variables: grades people received in their sixth grade math course (M); grades in sixth grade English (E); grades in sixth grade physical education (PE); grades in sixth grade history (H); grades in any elementary school art course (A); gender (G); and intelligence quotient (IQ). If information is gathered for a training set of m people, where “m” is a positive integer, then each of m observations has 7 entries, one for each variable, for a total of m×7 entries contained in the data set 10.

FIG. 1 also illustrates an exemplary target variable (Y), which contains a plurality of ranges or range “bins” for a person's yearly income in U.S. dollars. In this example, the target variable may also be represented as a pure continuous variable having a range of $0 to some predetermined maximum value. It is possible that some of the predictor variables (M, E, PE, H, A, G, IQ) of the data set 10 have strong predictive value of the target variable (Y), while others have low predictive value. As well known in the art, the data set 10, or at least a subset thereof, can be used as “training data” to create a statistical model that provides a predictive correlation between the predictive variables and the target variable. It is understood that the variables illustrated in FIG. 1 are exemplary only and that the invention is not limited to any particular type of variables or data. Rather, the invention may be utilized to automatically analyze any type of data or variables to determine whether they have statistical relevance to solving a particular problem or query.

In one embodiment, the steps required by a user to build a statistical model are minimized. The user simply connects to an ODBC-compliant database (e.g., Oracle, SQL Server, DB2, Access) or a flat text file and selects a data set or table for analysis. The user then specifies a field or name that serves as the unique identifier for the data set and a variable that is the target for modeling. This target variable is the variable of interest that is hypothesized to depend in some fashion on other fields in the data set. As another example, a marketing manager might have a database of customer attributes and a “yes” or “no” variable that indicates whether an individual has made purchases using the company's web portal. The marketing manager can select this “yes” or “no” field as the target variable.

Based on this data set and the target variable selected by the manager, the method and system of the invention can automatically build a model attempting to explain how the propensity to make online purchases depends on other known customer attributes. Some of the processes performed during this automatic model building process are described in further detail below, in accordance with various embodiments of the invention.

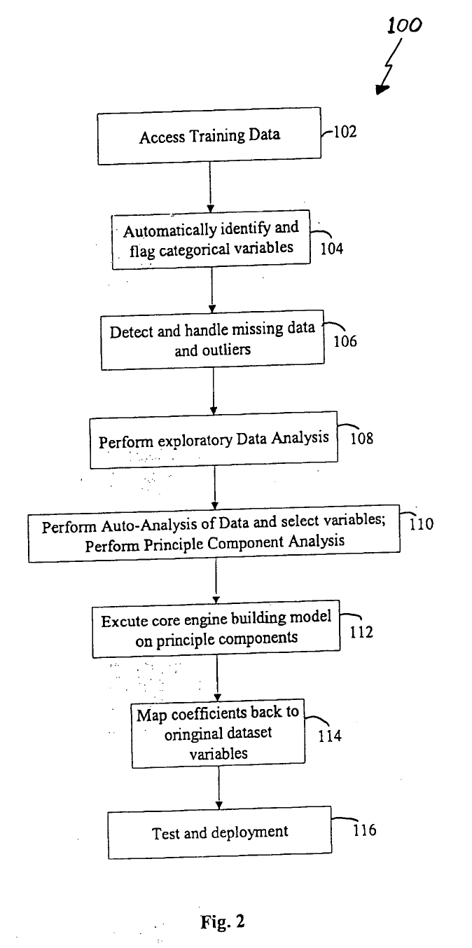

FIG. 2 illustrates a flow chart diagram that provides a general overview of a method of automatically building a statistical model, in accordance with one embodiment of the invention. The process 100 begins at step 102 where training data comprising data set variables and at least one target variable are accessed or retrieved from memory of a computer system (not shown). As apparent to those skilled in the art, the methods and systems described herein are computer-based methods and systems and any computer or data processing system known in the art having sufficient processing power and capacity may be utilized to execute software that performs the steps and processes described herein.

In the art of statistical analysis, two common types of variables are “categorical” and “continuous” variables. The characteristics and differences between these two types of variables are well known in the art. At step 104, variables in the training set are analyzed and identified as either continuous or categorical variables and all categorical variables are flagged. Since categorical and continuous variables are typically treated differently when performing statistical analysis, in one embodiment, the user is given the opportunity to manually specify which variables in the data set are categorical variables, with all others deemed to be continuous. Alternatively, if the user is not a trained analyst or does not want to perform this task manually, the user can request automatic identification and flagging of “likely” categorical variables. In a further embodiment, the user is given the opportunity to over-ride any categorical flags that were automatically created.

Next, at step 106, missing and outlier data is detected and processed accordingly, as described in further detail below. At step 108, exploratory analysis of the data is performed. At step 110, automatic analysis of the data to build a statistical model is performed. In one embodiment, this step is performed by an Automatic Model Building (AMB) algorithm or module, which is described in further detail below. At step 112, the results of the analysis of step 110 are then used by a core engine software module to build the statistical model. Next, at step 114, coefficients calculated during step 112 are mapped back to the original variables of the data set. Lastly, at step 116, the model is tested and, thereafter, deployed. Each of the above steps is described in further detail below.

In one embodiment, the steps of automatically analyzing a data set and building a model are performed in accordance with an Automatic Model Building (AMB) algorithm. Exemplary pseudo-code for this AMB software module is attached hereto as Appendix A. In preferred embodiments, the AMB software program provides the user with an easy to use graphic user interface (GUI) and an automatic model building solution.

As described above, the invention automatically performs various tasks in order to analyze and “cleanse” the data set for purposes of building a statistical model with minimal human intervention. These tasks are now described in further detail below.

Identifying and Flagging Categorical Variables

In one embodiment, a process for automatically identifying and flagging categorical variables (step 104) is performed in accordance with the exemplary pseudo code attached as Appendix B. In one embodiment, the field or record type (e.g., boolean, floating point, text, integer, etc.) is known in advance (e.g., data comes from a database with this information). Alternatively, if data comes from, e.g., a flat file, well-known techniques may be used to determine the types of fields or records in the data set.

In one embodiment, a solution to the problem of too many categories in a particular variable is to combine or “collapse” adjacent categories (e.g., A and B) when the max p-value for the adjacent categories is greater than or equal to Tmin, as provided for in the pseudo-code of Appendix B.

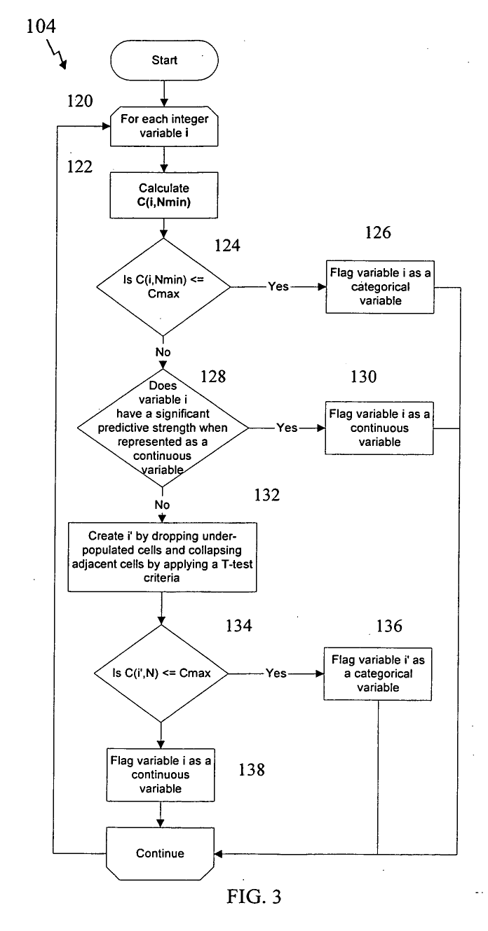

When a variable contains a large number of integer entries, it is often times difficult for an untrained user to determine whether it is a continuous or categorical variable. FIG. 3 illustrates a flow chart diagram of a process of analyzing variables containing integer values in order to classify and flag such variables as either categorical or continuous, in accordance with one embodiment of the invention. At step 120, a variable i within a data set that contains integer values as entries is retrieved for processing. At step 122, the number of unique values within variable i with more than Nmin observations or entries (C(i, Nmin)) is calculated. Next, at step 124, it is determined whether C(i, Nmin) is less than or equal to a predetermined upper bound selected for a categorical variable (Cmax). If it is determined that C(i, Nmin) is less than or equal to Cmax, then at step 126, the variable i is flagged as a categorical variable and the process returns to step 120 where the next variable i containing integer values is retrieved for processing.

If at step 124, C(i, Nmin) is determined to be greater than Cmax, then at step 128 a query is made as to whether the variable i has significant predictive strength when treated as a continuous variable. Known techniques may be used to answer this query such as calculating the value of Pearson's r or Cramer's V for the variable with respect to the target variable. If it is determined that the variable i does have significant predictive strength when represented as a continuous variable, then at step 130, the variable is flagged as a continuous variable and the process returns to step 120 where the next variable i containing integer values is retrieved for processing until all such variables have been processed. Otherwise, the process proceeds to step 132 wherein a new variable i′ is created by collapsing adjacent cells by applying a T-test criteria, in accordance with one embodiment of the invention.

At step 134, the process determines whether the number of unique values within the new variable i′ (C(i′, N)) is less than or equal to Cmax. If so, at step 136, variable i′ is flagged as a categorical variable. Else, at step 138, the original variable i is flagged as a continuous variable. After either step 136 or 138, the process returns to step 120 where the next variable i containing integer values is retrieved for processing until all variables i having integer values as entries or observations have been processed.

As described above, if a user has limited information regarding the characteristics of potential predictor variables and/or if the user is untrained in the art of statistical data analysis, the invention provides a powerful tool to the user by automating the analysis and flagging of variable types for the user. Additionally, the invention safeguards against or minimizes the potential of debilitating effects to model building that result when a user incorrectly or unwisely specifies a variable with hundreds of unique values as a categorical variable.

Handling Missing Data and Outliers

It is a rare and fortuitous occasion when a data set exhibits no missing values. More often missing values are encountered for many if not all the fields or variables in a data set. Some fields may have only a few missing values, while for others more than half of the values may be missing. In one embodiment, the method of the invention deals with missing values in one of two ways, depending on whether the field is continuous or categorical. For continuous variables, the method substitutes for the missing values the mean value computed from the non-missing entries and reports the number of substitutions for each field. For categorical variables, the invention creates a new category that effectively labels the cases as “missing.” In many applications, the fact that certain information is missing can be used profitably in model building and the invention can exploit this information. In one embodiment, in the case of incomplete datasets, the missing counts of the severely missing observations are presented to the user (perhaps in a rank order format). She or he then has the option to either eliminate those observations or variables from the design matrix or substitute corresponding mean values in their place.

Outliers, on the other hand, are recorded data so different from the rest that they can skew the results of calculations. An example might be a monthly income value of $1 million. It is plausible that this data point simply reflects a very large but accurate and valid monthly income value. On the other hand, it is possible that the recorded value is false, misreported or otherwise errant. In most situations, however, it is impossible to ascertain with certainty the correct explanation for the suspect data value. In practice, a human analyst must decide during exploratory data analysis whether to include, exclude, or replace each outlier with a more typical value for that variable. In one embodiment, the invention automatically searches for and reports potential outliers to the user. Once detected, the user is provided with three options for handling outliers. The first option involves replacing the outlier value with a “more reasonable” value. The replacement value is the data value closest to a boundary of “reasonable values,” defined in terms of standard deviations from the mean. Under the second option, the record (row) of the data set with the suspect value is ignored in building and estimating the model. The final option is to simply do nothing, i.e., leave data as is and proceed.

In one embodiment, outliers in a given (continuous) variable are identified by using a z-test with three standard deviations. For example, assume x=(x₁, x₂, . . . , x_{M}) is an observation vector for a variable and xₘₑₐₙ,sd are its mean and standard deviation, respectively, an entry xᵢ is considered an outlier if the following relation holds:
|xᵢ−xₘₑₐₙ|>3*sd

If a continuous variable has an exponential distribution, it should be log-scaled first before the outlier test above is conducted. The following pseudo-code describes the process:

```
For (each continuous predictor)
    If (the predictor is exponentially distributed)
        Log-scaling the predictor
    End If
    Perform the outlier detection
End For
```

As discussed above, in one embodiment, three handling options for outliers are provided to the user:

1. Substitute with MAX/MIN non-outlier value.

2. Keep (this is a do-nothing option)

3. Delete the corresponding record

In one embodiment, option 1 above is automatically selected as the default option and, during the training stage, outliers, once detected, are replaced by the highest (or lowest) non-outlier value within the vector, unless either of options 2 or 3 are manually selected by the user. In a further embodiment, in the default mode, these highest and lowest non-outlier values are also used to substitute any possible outliers (i.e., those outside the variable range in the training set) in the testing and deployment datasets as well. In a further embodiment, during deployment, all outliers are counted and a warning with an outlier summary is issued to the user.

Exploratory Data Analysis

Exploratory data analysis is the process of examining features of a dataset prior to model building. Since many datasets are large, most analysts focus on a few numbers called “descriptive statistics” that attempt to summarize the features of data. These features of data include central tendency (what is the average of the data?), degree of dispersion (how spread out is the data?), skewness (are a lot of the data points bunched to one side of the mean?), etc. Examining descriptive statistics is typically an important first step in applied modeling exercises.

Univariate statistics pertain to a single variable. An exception is the sample correlation, which measures the degree of linear association between a pair of variables. Univariate statistics include well known calculations such as the mean, median, mode, quartiles, variance, standard deviation, and skewness. All of these statistical measures are standard and well-known formulas may be used to calculate their values. The correlation measure depends upon the underlying type of variables (i.e., it differs for a continuous-continuous pair and for a continuous-binary pair). Exemplary pseudo-code for computing common univariate statistical measures is provided in Appendix C attached hereto.

Identifying and Log-Scaling Exponential Variables

In one embodiment, the models constructed by the invention are linear in their parameters. Linear models are quite flexible since variables may often be transformed or constructed so that a linear model is correctly specified. During the exploratory data analysis phase of a modeling project, statisticians frequently encounter variables that might reasonably be assumed to have an exponential distribution (e.g., monthly household income). Statisticians will often handle this situation by transforming the variable to a logarithmic scale prior to model building. In one embodiment, the method and system of the invention replicates this exploratory data analysis by determining for each variable in the data set whether an exponential distribution is consistent with the sample data for that variable. If so, the variable is transformed to a logarithmic scale. The transformed variable is then used in all subsequent model-building steps.

In most cases, linear regression modeling assumes all continuous variables are normally distributed. But in practice some of the given continuous variables can be exponentially distributed. In such circumstances, the AMB module detects and log-scales such exponentially distributed variables.

It is assumed that the log-scaling transformation helps convert an exponentially distributed variable (once detected) into a normally distributed variable. As a distribution test for a given variable, the variable is first sorted and then a sample of size n is selected with an evenly indexing distance. Then, the variable is log-scaled and the KS-test is used to determine whether it has a normal distribution. In one embodiment, detecting exponential variables is performed in accordance with the exemplary pseudo-code illustrated in Appendix D attached hereto.

If a continuous variable is exponentially distributed, it is log-scaled in order to transform its distribution to a normal one. The log-scale formula roots from the following distribution test

$$x = 1 - {ⅇ}^{\frac{x - x\_min}{x\_min - x\_mean}}$$

where x_mean and x_min is a sample mean value and the sample minimum value of predictor x, respectively. In one embodiment, the step of log-scaling an exponentially distributed continuous variable is performed in accordance with the exemplary pseudo-code provided in Appendix E.
Auto-Analysis of Data to Build Model

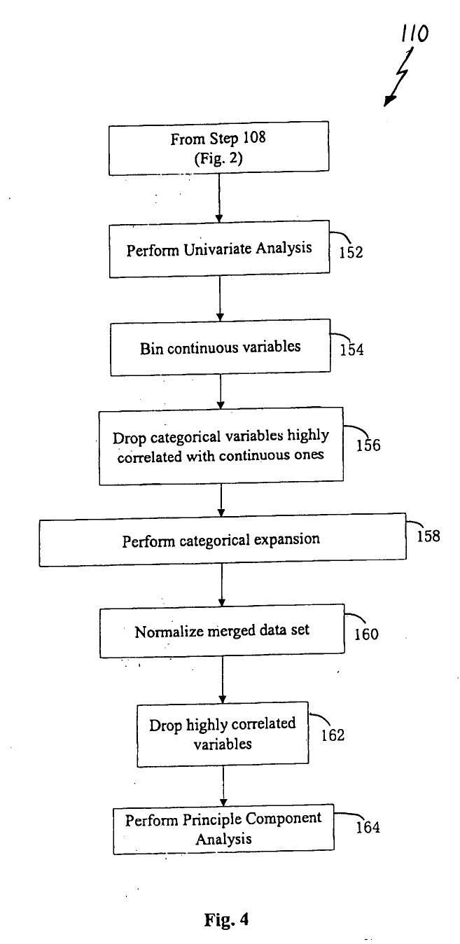

Referring again to FIG. 2, after exploratory data analysis is completed at step 108, the method of the invention proceeds to step 110, where further analysis of the data is performed in order to build a statistical model. FIG. 4 provides a flow chart diagram illustrating in finer detail some of the steps that are automatically performed in step 110 of FIG. 2, in accordance with one embodiment of the invention.

As shown in FIG. 4, at step 152, a univariate analysis is performed on each of the variables in the data set in order to filter out variables that have low correlation with the target variable. In one embodiment, the invention is embodied in a software program executed by a computer (not shown) wherein the program performs a multitiered variable filtration/selection process. In a first stage, the program applies a filter based on univariate predictive ability. The filter application varies with the number of potential predictors considered. For a relatively small number of predictors, no variables are removed. For larger sets of predictors, a subset of predictors with the worst univariate predictive performance is discarded. The objective at this stage is simply to reduce the number of potential predictors to a manageable size for further investigation. In one embodiment, univariate analysis is performed in accordance with the exemplary pseudo-code illustrated in Appendix F attached hereto.

Variables that survive the first filtration stage are then standardized. The motivation behind standardization is to maximize computational efficiency in subsequent steps. One advantage of standardizing the predictors is that the resulting estimated coefficients are unit-less, so that a rescaling of monthly income from dollars to hundreds of dollars, for example, has no effect on the estimated coefficient or its interpretation.

Next, at step 154, the program bins continuous variables so that they may be compared to each of the categorical variables to determine whether the information contained in the categorical variables appears largely redundant when considered along with the continuous variables. Those categorical predictors that appear redundant are discarded, while those that remain are expanded into a set of dummy variables, i.e., variables that take the value I (one) for a particular category of the variable and the value 0 (zero) for all other categories of the variable.

In order to compare categorical variables with continuous variables, however, the continuous variables must first be “binned” per step 154. Since there is no direct correlation measurement for a continuous variable and a categorical variable, each continuous variable is binned into a pseudo-categorical variable and, thereafter, Crammer's V is applied to measure the correlation between it and a real categorical variable. In one embodiment, continuous values are placed into bins based on the position they reside on a scale. First, the number of bins (n) is determined as a function of the length of the vector. Then, the range of the continuous variable is determined and divided into n intervals. Lastly, each value in the continuous variable is placed into its bin according to the value range it falls in. In this way, the program creates an ordinal variable from a continuous one. If categories of a categorical variable are highly associated with the newly created ordinal variable, the Crammer's V will be high, and vice versa. In one embodiment, a continuous variable is binned in accordance with the exemplary pseudo-code provided in Appendix G attached hereto.

As discussed above, in one embodiment, during univariate analysis, some variables that are weakly related with target variable are filtered out of the data set. If there are both continuous and categorical variables, before merging them, the method of the invention attempts to eliminate the co-linearity between categorical variables and continuous ones.

After binning a continuous variable as discussed above, Cramer's V is used to evaluate the correlation between the binned continuous variable and a “real” categorical variable. In one embodiment, if the Crammer's V value is above a threshold, the categorical variable is discarded because categorical variables will typically be expanded into multiple dummies and occupy much more space in the design matrix than continuous variables. This process of eliminating categorical variables that are highly correlated with continuous variables is performed at step 156 in FIG. 4. In one embodiment, the process of eliminating collinear categorical variables is performed in accordance with the exemplary pseudo-code illustrated in Appendix H.

Next, after redundant categorical variables have been discarded in step 156, the program proceeds to step 158 and executes a process of expanding each of the remaining categorical variables into multiple dummy variables for subsequent model-building operations. One objective of this process is to assign to categorical variables some levels in order to take account of the fact that the various categories in a variable may have separate deterministic effects on the model response.

Typically there are multiple categories present in a categorical variable. Therefore, in one embodiment, the method of the invention assigns a dummy variable to each category (including the “missing” category) in order to build a linear regression model. A simple categorical expansion may introduce a perfect co-linearity. In fact, if a categorical variable has k categories and we assign k dummies to it, then any dummy will be a linear combination of the remaining k-l dummies. To avoid this potential problem, in one embodiment, one dummy that is the least represented (in population), including a “missing” dummy, is eliminated. In one embodiment, the step of expanding categorical variables is performed in accordance with the exemplary pseudo-code provided in Appendix I attached hereto.

Next, at step 160, all continuous variables and dummies are normalized before further processing and analysis of the data is performed. To obtain principle components, the data set must first be normalized. After normalization, each variable becomes a unit-norm 1 and the sum of all entries of the variable is 0. For each variable x, in a vector format, the formula of normalization is as follow:

$$x = \frac{x - \overline{x}}{‖ x - \overline{x} ‖} ,$$

\overline{x} is mean of x and ∥x∥ is norm of x.

$$\overline{x} = \frac{{\sum }_{i = 1}^{n} x ( i )}{n} ,$$

n is the length of vector x

$$‖ x ‖ = \sqrt{{\sum }_{i = 1}^{n} {x ( i )}^{2}} ,$$

n is the length of vector x

In one embodiment, the step of normalization is performed in accordance with the exemplary pseudo-code provided in Appendix J attached hereto.

At step 162, a second stage filtration of potential predictors involves examining the sample correlation matrix for the normalized predictors to mitigate the potential of multicollinearity and drop variables that are highly correlated with other variables. At this stage, the remaining variables are either continuous or dummy variables. Perfect multicollinearity occurs when one predictor is an exact linear function of one or more of the other predictors. The term multicollinearity generally refers to cases where one predictor is nearly an exact linear function of one or more of the other predictors. Multicollinearity results in large uncertainties regarding the relationship between predictors and the target variable, (large standard errors in null hypothesis test, which examines whether the coefficient on a particular variable is zero). In the extreme case, perfect multicollinearity results in non-unique coefficient estimates. In short, the second stage filter attempts to mitigate problems arising from multicollinearity.

In one embodiment, if two variables exhibit a high pairwise correlation estimate, one of the two variables is dropped. The choice of which of the pair is dropped is governed by univariate correlation with the target. While this procedure detects obvious cases of multicollinearity, it cannot uncover all possible cases of multicollinearity. For example, a predictor may not be highly correlated with any other single predictor, but might be highly correlated with some linear combination of a number of other predictors. By limiting consideration to pairwise correlation, models can be built more quickly, since searching for arbitrary forms of multicollinearity is often time consuming in large data sets. In other embodiments, however, when the time required to build a model is less of a priority, more comprehensive searching of multicollinearities may be performed to eliminate further redundant predictors or variables and build a more efficient and robust model.

Thus, in preferred embodiments, the method of the invention performs a second-stage variable filtering process after an initial variable screening has been performed. Some highly correlated variables (continuous and/or newly expanded dummies) are eliminated through the formulation of their normal equation matrix. Given a set of variables (or a design matrix), its normal equation represents a correlation matrix among these variables. For each pair of variables, if their correlation is greater than a threshold (in one embodiment, the default value is 0.8), then the pair of variables is considered to multicollinear and one of them should be eliminated. In order to determine which variable should be eliminated, the correlation values between each of the two predictive variables and the target variable are calculated. The predictive variable with a higher correlation to target value is kept and the other one is dropped. In one embodiment, the process of eliminating multicolinearities is performed in accordance with the pseudo-code provided in Appendix K attached hereto.

At step 164, the normalized variables that survive the preceding filtration steps are combined into a data matrix and then Principle Components Analysis (PCA) is performed on this matrix. PCA techniques are well known in the art. Essentially, PCA derives new variables that are optimal linear combinations of the original variables. PCA is an orthogonal decomposition of the original data matrix, yielding orthogonal “component” vectors and the fraction of the variance in the data matrix represented or explained by each component.

In one embodiment, the invention applies a final filter by dropping components that account for only a small portion of the overall variance in the sample data matrix. All other components are retained and used to estimate and build a deployable model.

Since principle components are linear combinations of variables, the regression on components has several advantages over the direct regression on variables. First, all components should be orthogonal to each other and hence there is no co-linearity. This property helps build a more robust regression model. Secondly, since a portion of components can represent the most variance of a dataset, a relatively small component design matrix can be used for model building.

Given a normalized data set X(m×n), where NE=X^{T}*X is its normal equation matrix, the following computation is performed:
[U S V]=SVD(NE);

where, U(n×n) is the loading matrix, each column is a singular vector of NE and V=U in this case; S(n×n) is a diagonal matrix that contains all singular values. The sum of the singular values is n. Next, a portion of the leading component from U is selected and W=X*U is computed. The vector W is then used to build a regression model. In one embodiment, PCA processing is performed in accordance with the exemplary pseudo-code provided in Appendix L attached hereto.

Model Building Based on the Resulting Design Matrix

After PCA processing is completed, the invention is ready to build a model using the retained components in the data set. Referring again to FIG. 2, at step 112, a core engine is executed to build the model.

In one embodiment, the core engine utilizes the conjugate gradient descent (CGD) method and a singular value decomposition (SVD) method to generate a least squares solution. Both the CGD and SVD methods are model optimization algorithms that are well known in the art.

In one embodiment, the core engine has a two-layer architecture. In this architecture, a SVD algorithm serves as the upper layer of the engine that is designed to deliver a direct solution to the general least squares problems, while the CGD algorithm is applied to a residual sum of squares function and used as the lower layer of the engine. In one embodiment, the initial solution for CGD is generated randomly. This two-layer architecture utilizes known advantages of both the SVD and CGD methods. While SVD provides a more direct and quicker result for smaller data sets, it can sometimes fail to provide a solution depending on the quality or characteristics of the data. SVD can be slower than CGD for larger data sets. The CGD method, on the other, while requiring more processing time to converge, is more robust and in many cases will provide a reasonable solution vector.

In one embodiment, the upper-layer of the engine—an SVD approach for solving general least squares problems, is performed in accordance with the exemplary pseudo-code provided in Appendix M attached hereto.

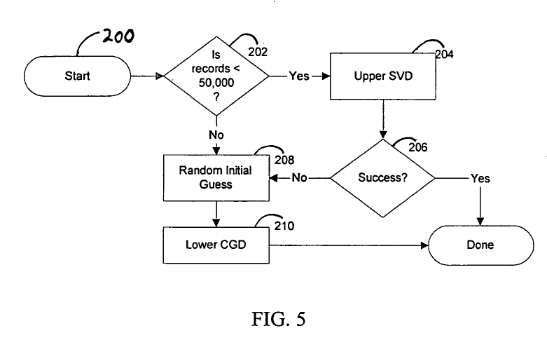

FIG. 5 illustrates a block diagram of the general decisions and processes performed by the core engine in accordance with one embodiment of the invention. At step 200, the engine determines whether the number of records in the data set is greater than 50,000. If yes, then at step 202, a SVD solution is computed to provide a direct solution to the general least squares problems. At step 204, the engine determines if the SVD computation was successful. If yes, the model building has successfully completed and the engine terminates at 210.

If it is determined that the number of records is greater than 50,000 (step 200) or the SVD computation was unsuccessful (step 204), then the engine utilizes the CGD method and, at step 208, calculates a random initial guess for a possible solution vector of the model. Next, at step 210, the CGD algorithm utilizes the initial random guess and applies its iterative algorithm to the residual sum of squares for the estimated target value and the observed target values.

The residual sum of squares is a function that measures variability in the observed outcome values about the regression-fitted values. The residual sum of squares is computed as follows: assume that Yⱼ, j=1, 2, . . . , K are the observed target values, and Ŷⱼ, j=1, 2, . . . , K the ucorresponding estimated values. Then, the residual sum of squares (in func) is defined as

$$Func ( X ) = {\sum }_{j = 1}^{K} {( {\hat{Y}}_{j} - {Y}_{j} )}^{2}$$

In a further embodiment, the multidimensional derivative of the objective function is also used during CGD processing by the core engine. Both the function and the corresponding derivative are repeatedly used in CGD to iteratively determine a best possible solution vector for the model.

In one embodiment, the functional derivative of the residual sum of squares is calculated as follows: assume that Xᵢⱼ, i=1, 2, . . . , M, j=1, 2, . . . , K is the value of the jth variable in the ith observation. Then, the functional derivative of the residual sum of squares (in dfunc) is given by

$${dfunc}_{j} ( X ) = 2 {\sum }_{i = 1}^{M} ( {\hat{Y}}_{i} - {Y}_{i} ) {X}_{ij} , \qquad j = 1 , 2 , … , K$$

The procedure dfunc may take a solution vector as its input parameter and compute, through the design matrix, and return the multidimensional function derivative vector.

Referring again to FIG. 2, at step 114, after a regression model has been built based on principle components, the PCA coefficients are “mapped back” to the original space of variables through the inverse of the loading matrix for the components before testing and deployment of the model. In one embodiment, component regression involves the following steps:

1. Normalized data set X(m×n), n variables selected from step 6 of the AMB algorithm (App. A);

2. NE=X^{T}*X is its normal equation matrix;

3. [U S V]=SVD(NE); We select some columns(say k<n columns) of U in step 7 of AMB algorithm;

4. W=X*U; We used W(m×k) to build model and get the model coefficients, β₀, β₁ . . . βₖ; 5. y=f(β₀+W*β=f(β₀+X*(U*β));

6. U*β is a vector of n by 1. Together with β₀ it forms the coefficient vector on variables, which will be presented to the user.

See Appendix A for further details. In one embodiment, the function of mapping coefficients back to the original variables is performed in accordance with the following exemplary pseudo-code:

| | |
|---|---|
| Input: | 1. Model coefficient on Principle Components [symbol] = (β₀,β₁,...,βₖ)^{T} |
| | 2. Loading matrix U(n × k); |

```
Output: 1. Model coefficient on variables [symbol] = (α₀,α₁,...,αₙ)^{T}
Parameter : None
Process:
            α0 = β₀;
            (α₁,...,αₙ)^{T} = U * (β₀,β₁,...,βₖ)^{T}
            return [symbol] = (α₀,α₁,...,αₙ)^{T}
```

Model Testing and Deployment

Now that the model is built, it is ready for step 116 where the model is tested (validated) and deployed. A first task is to pre-process the test/deployment dataset to a format and structure which is the same as that of the training set. If the test data set is a subset of the original data set for which pre-processing has already been performed then the following steps may be omitted for executing the model on the test data.

If a record in the deployment set has missing values, or contains values outside the ranges defined by the training set, it will be marked invalid, and a summarized report is issued to the user. Before applying a model to a dataset, the data must be pre-processed and formatted in the same way as the training data set. Based on the variable attributes and information collected during the exploratory data processing on the training set, the invention preprocesses and then scores a deployment dataset. For example, if an original raw variable is not selected during model building, it will be dropped and not processed during deployment.

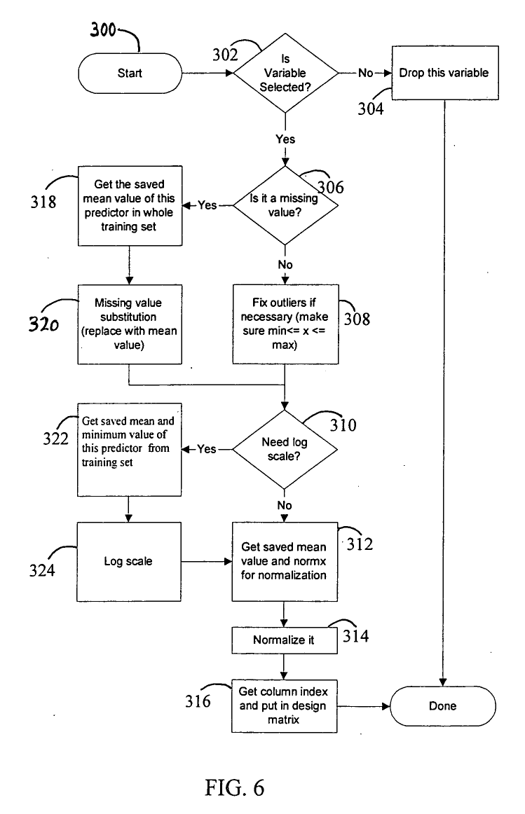

FIG. 6 illustrates a flow chart diagram for preprocessing continuous variables, in accordance one embodiment of the invention. From starting point 300 the process proceeds to step 302 to determine whether a current variable was selected (i.e., survived filtration/elimination) during the model building process. If no, at step 304, the variable is dropped and not considered further. If the variable was a selected variable, at step 306, the process queries whether it is a “missing” variable. If no, then at step 308, outliers are detected and handled. Next, at step 310, the process queries whether the variable has an exponential distribution and needs to be log-scaled. If no, then at step 312, the mean value and normx value is retrieved to normalize the variable. At step 314, the variable is normalized and, at step 316, the process obtains the design matrix column location or index for the variable and puts the variable in a corresponding column in a deployment data matrix. Thereafter, the process is done.

If at step 306, the variable is determined to be a missing value, then, at step 318, the process retrieves the saved mean value of the variable calculated from the training set. Next, at step 320, the missing value is substituted with the mean value and the process moves to step 310. If, at step 310, it is determined that the variable is exponentially distributed and requires log-scaling, then, at step 322, the process retrieves a saved mean value of a predetermined number of samples of the variable from the training set as well as a minimum value of samples. Then, at step 324, these values are used to log-scale the variable. The process then performs steps 312-316 as described above and, thereafter, is done.

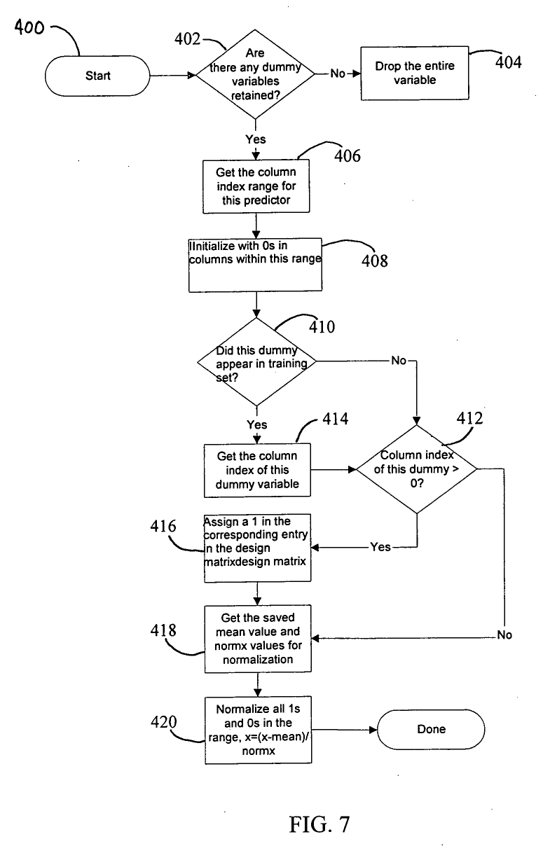

FIG. 7 illustrates a flow chart diagram for a method of pre-processing categorical variables for deployment, in accordance with one embodiment of the invention. The process starts at 400 and, at step 402, queries whether any dummy variables have been retained in the training set for that variable during model building. If no, then, at step 404, the variable is dropped from further consideration. If dummy variables were retained during model, then at step 406, the process retrieves the column index range for the variable. Next, at step 408, the columns in this range are initialized with “0's.” At step 410, the process queries whether the current dummy variable appears in the training set. If a particular dummy does not appear in the training set, then at step 412, the process queries whether the column index for that dummy is greater than 0. If yes, then at step 416, a “1” is assigned in the corresponding entry in the design matrix. If the answer is no, then at step 418, the process retrieves the save mean value and normx values for normalization. Then, at step 420, the process normalizes all 1's and 0's in the range, x=(x-mean)/normx.

If at step 410, it is determined that the dummy did appear in the training set, then at step 414, the process retrieves the column index of the dummy variable in the training data matrix or a data design matrix. Note that in one embodiment, the training data matrix is a subset of the data design matrix, which also contains test data that is subsequently used for testing the model. After step 414 is completed, the process then proceeds to step 412 and executes steps 412 and 416-420 as described above.

In one embodiment, a method of pre-processing continuous and categorical variables, respectively, for deployment is performed in accordance with the exemplary pseudo-code provided in Appendix N attached hereto.

Model Output Statistics

When many potential predictors are used in building a model, there is always the potential for over-fitting. Over-fitting refers to fitting the noise in a particular sample of data. The concern of over-fitting is that in-sample explanatory power may be a biased measure of true forecasting performance. Models that over-fit will not generalize well when they make predictions based on new data. One remedy for the problem of over-fitting is to split the data set into two subsets prior to estimating any unknown model, one dubbed the “training” set and the other the “validation” set. Model parameters are then estimated using only the data in the training subset. Using these parameter estimates, the model is then deployed against the validation set. Since the validation data are effectively new, model performance on this validation set should provide a more accurate measure of how the model will perform in actual practice.

After the model has been built and tested, model output statistics can be computed in order to provide a set of useful summary measures in describing, interpreting and judging the resulting model. In one embodiment, these output statistics are classified into two categories: one is associated with individual model coefficients; the other is related to the overall regression model (as an entity).

In one embodiment, most of the standard and important statistics for general linear regression models that typically can be found in popular statistics software packages are outputted. The following lists these model output values with some brief descriptions.

Category I (Model Coefficient)

Predictor names
Standard Error (SE) for each model coefficient—The square root of variance for each estimated regression coefficient. SE is computed only on the training set.
Estimated model coefficients—the model solution vector
Confidence interval for each model coefficient—An interval estimation that provides a range of possible values with a certain level of confidence. CI is computed only on the training set.
Significance t-test for each model coefficient (H₀: coefficient=0)—a hypothesis test on individual regression coefficient. T-test as well as its p-values are computed only on the training set.
   Category II (Overall Model)
R²—(including SSE and SSR) this is the most popular performance metric for linear regression models. It measures the proportion of total variation about mean of target values explained by the regression. Another name for R² is the coefficient of multiple determination. Note that 0<=R²<=1. The larger it is, the better the fitted regression equation explains the variation in the data. R² is computed on both sets (testing and training).
Adjusted R²—A related statistics, which might be more suitable in some applications, is the adjusted R². It is the R² weighted by the number of independent variables and observations.
AIC (Akaike information Criterion)—It is a model performance metric that can be used to compare different fitted models. The smaller the AIC, the better the fit. AIC also provides a balance between the fit and the number of predictors.
As a final model fitness metric, AIC is computed on the testing set. However, AIC is repeatedly computed on the training set for variable selection inside the stepwise process.
BIC (Bayesian Information Criterion, also known as Schwarz's Bayesian Criterion (SBC))—It an alternative to AIC. As a final model fitness metric, BIC is computed on the testing set. However, BIC is repeatedly computed on the training set for variable selection inside the stepwise process.
Significance F-test—It is a hypothesis test on the overall regression equation (the hypothesis that all regression coefficients are significant at some confidence level). F-test as well as its p-values are computed only on the training set.
Mean Squared Error (MSE)—a statistic used to measure the efficacy of prediction. MSE is computed on both sets (testing and training)
Sum of Squares of the Error (residual) (SSE). SSE is computed only on the testing set.
Sum of Squares due to the Regression (SSR). SSR is computed only on the testing set.
A further detailed discussion about computing performance statistics for a model based on a data matrix X is provided below. Assume X is a given design matrix (including the bias term) of dimension M by N, y=(y₁, y₂, . . . , y_{M}) are the observed target values, yₘₑₐₙ=mean(y), and z=(z₁, z₂, . . . , z_{M}) the predicted target values.
   SE for Each Model Parameter

The estimated coefficient \hat{β}ⱼ is normally distributed with variance σ²vⱼⱼ, where vⱼⱼ is jth diagonal entry of (X^{T}X)⁻¹. σ² is unknown and its estimate is given by

$${s}^{2} = \frac{{\sum }_{i = 1}^{M} {( {z}_{i} - {y}_{i} )}^{2}}{M - N}$$

$$Then , \\ \begin{matrix}{SE}_{j} = s \sqrt{{v}_{jj}} , & j = 1 , 2 , … , N\end{matrix}$$

Confidence Interval (CI) for Each Model Parameter

A 100(1−α) % CI (α=0.05) on the coefficient βⱼ is given by
\hat{β}ⱼ±t_{M-N,α/2}SEⱼ, j=1, 2, . . . , N

where t_{M-N,α/2} is the upper α/2 critical point of the t-distribution with M−N d.f. and SEⱼ is the estimated standard error for the coefficient.

Significance T-Test

Under the hypothesis that the coefficient βⱼ is zero, an α-level t-test rejects the hypothesis if

$$\vert {t}_{j} \vert = \frac{\vert \hat{{β}_{j}} \vert}{{SE}_{j}} > {t}_{M - N , α / 2} , \qquad j = 1 , 2 , … , N$$

where t_{M-N,α/2} is the upper α/2 critical point of the t-distribution with M−N d.f. and SEⱼ is the estimated standard error for βⱼ.

R²

It can be defined as

$${R}^{2} = 1 - \frac{SSE}{{\sum }_{i = 1}^{M} {( {y}_{i} - {y}_{mean} )}^{2}}$$

SSE (Sum of Squares of the Error (Residual))

$$SSE = {\sum }_{i = 1}^{M} {( {z}_{i} - {y}_{i} )}^{2}$$

SSR (Sum of Squares Due to the Regression)

$$SSR = {\sum }_{i = 1}^{M} {( {z}_{i} - {y}_{mean} )}^{2}$$

When over-fitting, the above R² can be a negative value and in this case it should be reset to zero. The R² measure is applied to both the training set and the testing set. If there is a large discrepancy in R² between these two sets, which likely indicates that an over-fitting model is generated, the system will issue a model-over-fitting warning to the user.

Adjusted R²

It is given by

$${R}_{a}^{2} = 1 - ( 1 - {R}^{2} ) ( \frac{M - 1}{M - N} ) ,$$

AIC

It is given by

$$AIC = ( log 2 π + log \frac{{\sum }_{i = 1}^{M} {( {z}_{i} - {y}_{i} )}^{2}}{M} + 1 ) + \frac{2 N}{M}$$

BIC

It is given by

$$BIC = ( log 2 π + log \frac{{\sum }_{i = 1}^{M} {( {z}_{i} - {y}_{i} )}^{2}}{M} + 1 ) + \frac{log ( M ) N}{M}$$

Significance F-Test

The F-statistic can be defined as

$$F = \frac{{\sum }_{i = 1}^{M} {( {Z}_{i} - {y}_{mean} )}^{2} / ( N - 1 )}{{\sum }_{i = 1}^{M} {( {z}_{i} - {y}_{i} )}^{2} / ( M - N )}$$

It can be shown that when the hypothesis (that all regression coefficients are insignificant) is true, the F statistic follows an F-distribution with N−1 and M−N d.f. Therefore an α-level test rejects the hypothesis if (α=0.05)
F>f_{N-1, M-N, α}

where f_{N-, M-N, α} is the upper a critical point of the F-distribution with N−1 and M−N d.f.

MSE

It is defined as

$$MSE = \frac{{\sum }_{i = 1}^{M} {( {z}_{i} - {y}_{i} )}^{2}}{M}$$

Various embodiments of a new and improved method and system for performing statistical analysis and building statistical models are described herein. However, those of ordinary skill in the art will appreciate that the above descriptions of the preferred embodiments are exemplary only and that the invention may be practiced with modifications or variations of the devices and techniques disclosed above. Those of ordinary skill in the art will know, or be able to ascertain using no more than routine experimentation, many equivalents to the specific embodiments of the invention described herein. Such modifications, variations and equivalents are contemplated to be within the spirit and scope of the present invention as set forth in the claims below.

```
APPENDIX A
    The following parameters are utilized by the AMB algorithm:
    Input: X - the given design matrix (continuous + categorical) (dimension: m × n, m = #
        of records, n = # of predictors);
        y - the dependent/target variable vector (dimension: m × 1)
        Output: s - the solution vector (the model parameter vector, including the “bias”
        term) (dimension: (n1+1) × 1)
Step 0
For each continuous predictor
    If (there is any missing observation value)
        Perform Missing Value Substitution
    End
Step 1
For each continuous predictor
    If (exponentially distributed)
        Log-scale the predictor and flag it
        End
    End
    Detect outliers
End
Step2
// Perform Univariate Analysis for all n predictors
If (size(continuous) > 0)
    For each continuous predictor
        Calculate its Pearson's r value (with the target)
    End
End
If (size(categorical) > 0)
    Bin the continuous target variable
    Calculate its Cramer's V value (on the binned target groups)
End
Sort continuous predictors in Pearson's R value
Sort categorical predictors in Cramer's V value
// Assume n = n_conti + n_cate, n_conti = # of continuous, n_cate = # of categorical
If n_conti > 200
    Retain top 135 + ((n_conti − 200)*0.3) (30% continuous with large R values)
Else if 100 < n_conti <= 200
    Retain top 85 + ((n_conti − 100)*0.5) (50% continuous with large R values)
Else if 50 < n_conti <=100
    Retain top 50 + ((n_conti − 50)*0.7) (70% continuous with large R values)
Else // n_conti <=50
    Retain all predictors
End
If n_cate > 200
    Retain top 135 + ((n_cate − 200)*0.3) (30% categorical with large V values)
Else if 100 < n_cate <= 200
    Retain top 85 + ((n_cate − 100)*0.5) (50% categorical with large V values)
Else if 50 < n_cate <=100
    Retain top 50 + ((n_cate − 50)*0.7) (70% categorical with large V values)
Else // n_cate <=50
    Retain all predictors
End
Step 3
If (size(categorical) > 0 & size(continuous)>0)
    // Merge categorical with continuous (in favor of continuous)
    Categorize continuous predictors
        For each categorical predictor c1
        For each continuous predictor c2
            Compute the Cramer's V value between c1 and c2
                If Cramer V(c1, c2) > 0.5
                Remove c1 from the retained list
            End
        End
    End
End
If (size(categorical) > 0)
    Expand all retained categorical predictors into dummies
End
If (size(categorical) > 0 && size(continuous) > 0)
    Formulate the new design matrix X by combining retained categorical and continuous
    predictors
End
Step 4
Normalize (not z-scaling) all retained predictors (X) and obtain the new design matrix X′
Step 5
Formulate the normal equation N = X′^{T.}X′ (matrix-matrix multiplication, dimension of N : n1 ×
n1)
//Filter out strongly collinear predictors
While there is an off-diagonal-element of lower_triangle(X′^{T.}X′) with its absolute value > 0.8
    // assume the index is (i, j) and i > j
    Compute the correlation r_i between the target and the ith predictor
    Compute the correlation r_j between the target and the jth predictor
    If r_i > r_j
        Remove jth predictor from the retaining predictor list
    Else
        Remove ith predictor from the retaining predictor list
    End
End
If any predictor deletion (above) performed
    Reformulate the design matrix X′ and the corresponding normal equation N = X′^{T.}X′
    (matrix-matrix multiplication)
    [m, n1] = size(X′)
End
Step 6
    Perform PCA on N via SVD(N) and obtain the loading matrix M (dimension: n1 × n1)
and the latent vector 1 (dimension: n1 × 1)
Step 7
If PCA successful (i.e., the SVD in PCA does not fail)
    Sort the latent vector 1 in increasing order and obtain the sorting index;
    Use singular values 1 and the sorting index to identify a few bottom components C (i.e.,
    the last d columns of M, dimension: n1 × d) that represents 10 % of variance accounted
    for;
    If (n1 − d < 10)
        Reformulate C by including only the last d2 (= n1 − 10) columns of M
        Reset d = d2
    End
    Scan all columns/components in C and delete d1 (<=d) components that don't have a
    predictive strength, i.e., |Pearson's R(target, component)| <0.3
Step 8
    k = n1−d1
    Formulate the Mapping matrix M′ from M (by removing those d1 components,
    dimension of M′ : n1 × k)
    While (k >= m)
        Delete the bottom components according to the singular value
    End While
    Reset k to the size of remaining components
    Compute A′ = X′M′ (matrix-matrix multiplication, dimension of A′: m × k)
Step 9
    Append the “bias” column (all 1's) to A′ as its (new) first column (dimension of A′: m ×
    (k+1))
    Pass A′ to Engine (SVD + possibly a random initial guess and CGD) for component
    regression and generate a solution vector w (dimension: (k+1) × 1)
Step 10
// Map w back to the predictor space
    -- Compute the solution vector s = M′ * w [2..k+1] (multiplication of matrix M′ and a
    partial vector of w (from w[2] to w[k+1]) (dimension of s : n1 × 1)
    -- Add the “bias” term (i.e., w[1]) to s as its (new) first entry (dimension of s : (n1+1) ×
    1)
Else // PCA failed
Steps 11
    Append the “bias” column to X′ as its (new) first column (dimension of X′ : m × (n1+1))
    While (n+1 >= m)
        Delete the remaining least correlated (with target) variable
    End While
    Reset n+1 to the size of retained design matrix
    Pass all retained predictors X′ to Engine (SVD + possibly a random initial guess and
CGD) for predictor regression and generate a solution vector s (dimension: (n1+1) × 1)
    End
```

APPENDIX B
Pseudo Code Algorithm - Identify Variables As Categorical Or Continuous

```
If (fieldtype = Boolean) then vartype = categorical
If (fieldtype = float) then vartype = continuous
If (fieldtype = text and C > Xmax) then variable is dropped
If (fieldtype = text and C ≦ Xmax) then vartype = categorical
If ((fieldtype = integer or long integer) and C ≦ Cmax) then
vartype = categorical
If ((fieldtype = integer or long integer) and C > Cmax) then
    If (Pearson's r > Rmin) then
        // Correlation between the target and this predictor
        vartype = continuous
    Else
        For each category c
            If (N_{c}< Nmin) then
                Recode record as missing
                //Note that this actually creates a new variable
        End For
        Recalculate C
        If (C = 0) then
            vartype = continuous
            Quit
        Else If (0 < C ≦ Cmax) then
            vartype = categorical
            Quit
        Else (C > Cmax)
            Sort bins in ascending order on those unique values
            Do until (MAX(p-value) < Tmin or C <= Cmax)
                For each adjacent pair of bins A and B
                    Construct the associated target subsets T_{A} and T_{B}
                    Perform T-test on T_{A} and T_{B} and calculate the
                    corresponding p-value
                End For
                Find MAX(p-value)
                // Note that MAX(p-value) = the maximum p-value
                across all //adjacent pairs of bins
                If (MAX(p-value) >= Tmin) then
                    Combine corresponding bins A and B.
                    C = C−1
            End Do
            Recalculate C
            If C ≦ Cmax then
                vartype = categorical
            Else
                vartype = continuous
                // Note that in this case we use the original variable
                both to
                    //build and deploy the model - undo possible
            collapses.
End All
```

where:
C=the count of the number of unique values (‘bins’) within a variable, exclusive of missing values;
N_{c}=the count of the number of records in the C^{th} bin;
Records=the count of the number of records;
Target=A continuous variable;
Xmax=the upper bound on the number of categories permitted for a text-valued categorical variable. The default value is 25;
Cmax=the upper bound on the number of categories permitted for an integer-valued categorical variable. The default value is 10;
Nmin=the minimum number of observations within a category. The default value is 5;
Rmin=the minimum level of Pearson's r for a continuous variable to be considered a “strong predictor.” The default value is 0.5;
Tmin=the cutoff significance level from the T-test to collapse adjacent cells. The default value is 0.05.

It is understood that the default values given above are exemplary only and may be adjusted in order to modify the criteria for identifying categorical variables.

Methods of performing T-test and p-value calculations are well known in the art. Given two data sets A and B, the standard error of the difference of the means can be estimated by the following formula:

$${S}_{D} = \sqrt{\frac{{\sum }_{A} {( {x}_{i} - {\overline{x}}_{A} )}^{2} + {\sum }_{B} {( {x}_{i} - {\overline{x}}_{B} )}^{2}}{size ( A ) + size ( B ) - 2} + ( \frac{1}{size ( A )} + \frac{1}{size ( B )} )}$$

where t is computed by

$$t = \frac{{\overline{x}}_{A} - {\overline{x}}_{B}}{{S}_{D}}$$

Finally, the significance of the t (p-value) for a distribution with size(A)+size(B)-2 degree freedom is evaluated by the incomplete beta function

### Appendix C

Mean

The sample mean is the most common measure of the central tendency in data. The sample mean is exactly the average value of the data in the sample. The implementation is as follows:

mean (N×1 vector X)→y (scalar)

1. Read in X

2. X*=rm.missing(X) (removes records w/missing values)

3. N*=rows(X*)

4. Call is.numeric(X*)
a. If result is false then return error “Data must be numeric”

5. Compute y using the following formula:

$$y = {\sum }_{i = 1}^{{N}^{*}} {X}_{i}^{*} / {N}^{*}$$

6. Return y

Max, Min, Median, Quartile and Percentile values characterize the sample distribution of data. For example, the α% of a data vector X is defined as the lowest sample value X such that at least α% of the sample values are less than X. The most commonly computed percentiles are the median (α=50) and quartiles (α=25, α=50 α=75). The interval between the 25^{th} percentile and the 75^{th} percentile is known as the interquartile range.

max.min (N×1 vector X)-→Y (2×1 vector containing min, max as elements)

1. Read in X

2. Remove missing and proceed (X now assumed non-missing)

3. Call is.numeric
a. If false then return error ‘data must be numeric’

4. Set Y[1]=kth.smallest(1)

5. Set Y[2]=kth.smallest(N)

6. Return Y

median (N×1 vector X)-→y (scalar)

1. Read in X

2. Remove missing and proceed (X now assumed non-missing)

3. Call is.numeric (see ads-other.doc)
a. If result is false then return error “Data must be numeric”

4. Compute k as the following:
a. If N is even k=N/2
b. Otherwise k=(N+1)/2

5. Call kth.smallest(k)

6. Return y=kth.smallest(k)

If N is even, statistics texts often report median as the average of the two ‘middle’ values. In one embodiment, the invention selects the N/2-th value. The reason is that with vary large data sets finding the computational time to find both values is often times not worth the effort.

percentile(N×1 vector X, P×1 vector Z containing the percentile values which must be between 0 and 1)-→Y (P×1 vector containing percentiles as elements)

Temporary Variables: Foo

1. Read in X

2. Remove missing and proceed (X now assumed non-missing)

3. Call is.numeric
a. If false then return error ‘data must be numeric’

4. Call is.percentage
a. If false then return error ‘percentile must be between 0 and 1’

5. For I=1, . . . , P:
a. Foo=floor(Z[I]*N)
   i. If Foo >0 then Y[i]=kth.smallest(Foo)
   ii. Else Y[i]=kth.smallest(1)

6. Return Y

quartile(N×1 vector X)-→Y (3×1 vector containing quartiles as elements)

Note: relies on percentile function (see above)

1. P=[0.25, 0.5, 0.75]

2. Y=percentile(X,P)

3. Return Y

Mode

The sample mode is another measure of central tendency. The sample mode of a discrete random variable is that value (or those values if it is not unique) which occurs (occur) most often. Without additional assumptions regarding the probability law, sample modes for continuous variables cannot be computed.

mode: (N×1 categorical vector X)-→y (scalar)

1. Read in X

2. Remove missing and proceed (X now assumed non-missing)

3. Call is.numeric
a. If result is false then return error ‘Data must be numeric”

4. Call is.categorical
a. If result is false then return error ‘Data must be categorical’

5. Call array to hold list of unique objects, count for each object, and a scalar ‘MaxCount’ variable to keep the current max count number in the array

6. Step through data and do the following:
a. Check to see if object matches any object on current token list
   i. If yes
      1. Increment counter for that object by 1
      2. Check against MaxCount and increm. MaxCount if necessary
   ii. Otherwise,
      1. Create new list item and set count for this item to 1
      2. Check against MaxCount and increm. MaxCount if necessary

7. Check counts against MaxCount and return those items that match MaxCount (this will be at least one item but may be more than one (‘bimodal’, ‘trimodal’ sample distribution).

Sample Variance, Standard Deviation

The sample variance measures the dispersion about the mean in a sample of data. Computation of the sample variance relies on the sample mean, hence the sample mean function (see above) must be called and the result is referenced as μₓ in the following formula: variance: (N×1 vector X)-→y (scalar)

1. Read in X

2. Remove missing and proceed (X now assumed non-missing)

3. Call is.numeric (see ads-other.doc)
a. If result is false then return error ‘Data must be numeric”

4. Call mean(X) and save result as μₓ
a. If mean(X) results in error then variance(X) returns error as well

5. Compute y using the following formula:

$${{σ}^{⋒}}^{2} = ( 1 / ( N - 1 ) ) {\sum }_{i = 11}^{N} {( {X}_{i} - {μ}_{X} )}^{2}$$

6. Return y

stddev: (N×1 vector X)-→y (scalar)

1. Read in X

2. y=variance(X)

3. y=sqrt(y)

4. return y

Correlation

Correlation provides a measure of the linear association between two variables that is scale-independent (as opposed to covariance, which does depend on the units of measurement).

corr(N×1 vector X, N×1 vector Y)-→z (scalar)

1. Read in X, Y

2. Remove missing and proceed (X, Y now assumed mutually non-missing—this means that all records where either x or y is missing are removed)

3. Call is.numeric (see ads-other.doc)
a. If result isfalse then return error ‘Data must be numeric”

4. Compute z using the following formula:

$$z = ( 1 / N ) {\sum }_{i = 1}^{N} ( {X}_{i} - {μ}_{X} ) ( {Y}_{i} - {μ}_{γ} )$$

5. Return z

Scenarios

The following example illustrates how these functions would be applied to a data vector X.

Let X=(1, 3, 6, 11, 4, 8, 2, 9, 1, 10)^{T}

mean X=5.5

mode X=1 (assuming here that these represent categories)

median X=4

variance X=13.05

stddev X=3.6125

APPENDIX D

| | |
|---|---|
| Input: | A continuous variable x of dimension m × 1 |
| Output: | 1. A flag indicating whether the input vector is exponentially |
| | distributed |
| | H = 1: yes; H = 0: no |
| | 2. The mean value meanv and minimum value minv of the |
| | sample |

Process:

| n = 51 | // sample size |
|---|---|
| x1 = [0:1/(n − 1):1] | // xl is a vector of length n, from 0 to 1 with |
| | step 1/(n − 1) |
| x2 = zeros(1, n) | // initialize a vector of zeros with the same |
| | length of x1 |
| B = sorted(x) | // in ascending order |
| idx = m * x1 | |
| idx = round(idx) | // index of samples |
| i = 1 | |
| While (idx(i) == 0) | |
| idx(i) = 1 | |
| i++ | |
| End While | // make sure indexes are not out of bound |
| idx(n) = m | // last sample is the maximum value |
| For i = 1:n | |
| x2(i) = B(idx(i)) | |
| End For | //x2 is the vector of samples |
| minv = x2(1); | //first element is the minimum value |
| meanv = mean(x2); | //mean value of samples |
| //log-scale x2 | |
| For i = 1:n | |

$Compute x2 ( i ) = 1 - {e}^{\frac{x2 ( i ) - min v}{min v - meanv}}$

| | |
|---|---|
| End For | // if x2 now is uniform distributed, x is |
| | exponential distributed |

//later is the KS test, test whether x1 and x2 have the “same” distribution
max_d = 0
For i = 1:n − 1

If (abs(x2(i) − x1(i)) > max_d)

max_d = abs(x2(i) − x1(i))

End If
If (abs(x2(i) − x1(i + 1)) > max_d)

max_d = abs(x2(i) − x1(i + 1))

End If

End For
If (abs(x2(n) − x1(n)) > max_d)

max_d = abs(x2(n) − x1(n))

End If
en = sqrt(n)
prob = probks((en + 0.12 + 0.11/en)*max_d)

If (prob > 0.3)

H = 1

Else

H = 0

End If
Return H, minv, meanv;

Sorting is done in ascending order.

APPENDIX E

| | |
|---|---|
| Inputs: | A continuous variable x of dimension m × 1; the mean value |
| | x_mean and the minimum value x_min from the output of |
| | the exponential distribution test function |
| Outputs: | The log-scaled x- bx of dimension m × 1 |

Process:

Initialize the return vector bx of dimension m × 1
For i = 1:m

$Compute bx ( i ) = 1 - {e}^{\frac{x ( i ) - min}{mean - min}}$

End For
Return bx
// x can not be a constant variable.

APPENDIX F

| | |
|---|---|
| Input: | 1. A continuous OR categorical dataset X |
| | 2. Target variable y is continuous |
| Output: | A filtered continuous or categorical dataset |
| Process: | |

| | |
|---|---|
| 1. | Bin the target y into a categorical variable bin_y |
| 2. | Calculate correlation of each variable x with y. |

If x is a continuous variable, the correlation is Pearson's R between x
and y; If x is a categorical variable, the correlation is Cramer's V
between x and bin_y.

| | |
|---|---|
| 3. | Let n equal the number of variables in the input dataset and k is |

the number of variables to be kept.
If (n <=50) k = n ;

| | |
|---|---|
| | Else If n <= 100 k = 50 + round(0.7 * (n − 50)) ; |
| | Else If n <= 200 k = 85 + round(0.5 * (n − 100)) ; |
| | Else k = 135 + round(0.3 * (n − 200)) ; |
| End If | |
| 4. | Sort the variables based on the absolute correlation value in |

descending order, and keep the first k variables. Store their indexes
and correlation values with y.

APPENDIX G

| | |
|---|---|
| Input: | A continuous variable x of dimension m × 1 (note: x cannot |
| | be a constant variable). |
| Output: | The binned x, bx, of dimension m × 1 |

```
Process:
    k is the number of bins
        If m < 1000
            k = 5
        Else If m <= 10000
            k = ceil(5 + 5 * (m − 1000)/9000)
        Else If m <= 100000
            k = ceil(10 + 10 * (m − 10000)/90000)
        Else
            k = 20
        End If
```

| | |
|---|---|
| maxv = max(x) | // the maximum value of x |
| minv = min(x) | // the minimum value of x |

range = maxv - minv

| | |
|---|---|
| bx = zeros(m,1) | // initialize a vector of dimension m × 1 to zeros |

```
If range > 0
    For i = 1:m
        bx(i) = ceil(k * (x(i) − minv)/range)
        If bx(i) < 1
            bx(i) = 1
        End If
        If bx(i) > k
            bx(i) = k
        End If
    End For
End If
Return bx.
```

APPENDIX H

| | |
|---|---|
| Input: | 1. A continuous dataset X1 |
| | 2. A categorical dataset X2 |

```
    Output: X1 untouched, X2 may get smaller by dropping some
    variables
    Parameter: CV, a threshold for Crammer's V value
    Process:
    1. Bin each continuous variable into a number of categories
    (if not already performed).
    2. For each of the categorical variable x2, compute the Crammer's V
value between x2 and each binned continuous one.
```

If the Cramer's V > the threshold CV,
Drop the categorical
End If

APPENDIX I

| | |
|---|---|
| Input: | a set of categorical variables X2of dimension M × N |
| Output: | an expanded dummies DX |

```
Process:
    Set DX as an empty matrix
    For each of the categorical variable x2 in X2
        Calculate k -- the number of its categories
        Initialize a matrix TX of size M × k with 0;
        For i = 1 to M,
            x = x2(i)
            q is the index for x; (1 <= q <= k)
            TX(i, q) = 1
        End For
        Find the column that has least 1s, say it is column d;
        (1<= d <= k);
        Delete column d from TX;
        Concatenate TX to DX vertically; // DX = [DX TX];
        Record category index and drop category name
    End For
```

```
APPENDIX J
Input: A dataset without any missing and no constant variables, X
Output: The normalized dataset, NX
Process:
    [m n] = sizeof(X);
    Initialize a matrix NX of size m by n;
    For i = 1:n
        x = X(: , i);  //x is the ith column of X
        x_mean = mean of x;
        For j = 1 to m,
            x(j) = x(j) − x_mean;
        End For
        x_norm = 0;
        For j = 1 to m,
            x_norm += x(j)²;
        End For
        x_norm = sqrt(x_norm);
        For j = 1 to m,
            x(j) /= x_norm;
        End For
        NX(: , i) = x; //ith column in NX is x
    End For
```

APPENDIX K

| | |
|---|---|
| Input: | 1. A dataset consist of continuous and dummy variables, |
| | it is normalized, X |
| | 2. Target variable, y |

```
Output: X, some variable might be dropped in the process
Parameter : Threshold of correlation, TC. Default 0.8. Range: 0.8˜0.95.
Process:
NE = X^{T}*X; //NE is the normal equation matrix,
each element is in its absolute //value
While there exists any element abs(NE(i,j)) > TC
cor1 = absolute value of correlation between xᵢ and y;
cor2 = absolute value of correlation between xⱼ and y;
If cor1 > cor2
    Mark xⱼ as dropped
    Fill 0s in jth row and jth column of NE;
Else
    Mark xᵢ as dropped
    Fill 0s in ith row and ith column of NE;
End If
End While
Delete variables in X that are marked to be dropped.
Delete the corresponding rows and columns in the normal equation
matrix NE.
Store names of the dropped continuous and dummy variables
```

APPENDIX L

| | |
|---|---|
| Input: | 1. A dataset consist of continuous and dummy variables that |
| | it is normalized, X; |
| | 2. A target variable y. |
| Output: | 1. Selected Principle Components W |
| | 2. Corresponding loading matrix U |
| | 3. success //a flag indicating whether SVD successful: 0; |
| | or not:0 |

Parameter : Percentage variance to keep AE. Default 0.9.
Range : 0.8˜0.95.
Process:

| NE = X^{T}*X; //NE is the normal equation matrix | |
|---|---|
| [U S V] = svd(NE); //use svdcmp function from Numeric Recipe | |
| If SVD succeeds | |
| success = 0 | |
| Else | |
| success = −1, | |
| W and U both empty | |
| End If | |
| Sort the singular values in S in descending order; | |
| Re-arrange columns in U, make them still correspond to their | |
| singular values; | |
| Set n = the number of columns in X; | |
| enough_e = n * AE; | |
| sume = 0; | |
| TU = empty; TW = empty; | |
| i = 1; | |
| While (sume < enough_e and S(i,i) > 0.1) | |
| TU = [TU, U(:,i)]; | //U(:,i) is the ith column of U |
| TW = [TW, W(:,i)]; | // W(:,i) is the ith column of W |

```
    sume += S(i,i);
    i++;
End While;
While (S(i,i) > 0.1)
    corr = absolute value of correlation of W(:,i) and y;
    If (corr > 0.3)
      TU = [TU, U(:,i)];
      TW = [TW, W(:,i)];
    End If
    i++;
End While
U = TU; W = TW;
Return W, U, success.
```

APPENDIX M

| | |
|---|---|
| 1. | Input the preprocessed design matrix X of dimension M x K |
| 2. | Input the observed outcome vector Y of dimension M x 1 |
| 3. | Compute the SVD of X, i.e., X = USV^{T}, where U = (U₁, |
| | U₂, . . . , Uₖ), V = (V₁, V₂, . . . , Vₖ) |
| | are left and right singular vectors, respectively |
| 4. | Compute the solution vector of the model as |

$β = {\sum }_{i = 1}^{K} ( \frac{{U}_{i} Y}{{σ}_{i}} ) {V}_{i}$

where σᵢ are the singular values, and UᵢY are the vector dot product
between Uᵢ and Y. In one embodiment, in order to avoid some potential
overflow that may occur in this step due to possible small singular values,
a threshold (e.g., 10e−5* max(singular values) to eliminate small values
is implemented.

A corresponding prototype code is listed below:

load X.dat;
load y.dat;
y = y′
[m, n] = size(X);
[U,S,V] = svd(X,0);
sigma = 10E−5 * S(1,1);
k = 0;
for i = 1:n

if(S(i,i) >= sigma)

k = k + 1;

end

end
beta = 0;
for i = l:k,

beta = beta + ((U(:,i)′*y)/S(i,i))*V(:,i);

end
beta

APPENDIX N
Proc continuous-process(x)
// x is a data entry/value
If the corresponding variable is not selected by AMB, return;
If x is a missing value

Mark this record invalid;
Substitute it with mean value;
//mean value of this variable in training set collected during AMB

Else

If x > max // maximum value of this variable in training set
collected during AMB

x = max;
Mark this record invalid;

End If
If x < min // minimum value of this variable in training set
collected during AMB

x = min;
Mark this record invalid;

End If

End If
If the corresponding variable is exponentially distributed

Retrieve the mean and min value for log-scaling;
// It is mean and minimum value of samples of this predictor in
training set when conduct
// exponential distribution test, might be different from those in
whole training set
$x = 1 - {e}^{\frac{x - min}{mean - min}} ;$

End If
Retrieve the mean and norm value for normalization;
$x = \frac{x - mean}{norm} ;$
Put x in the design matrix according to its column index and row number.
Proc categorical-process(x)

// x is a data entry/value, m is the number of records
If the corresponding dummy is not retained in the model then Return;

Get the column index of this categorical variable in the
design matrix [i:j];

//1 <=i<j;

Fill 0s in entry(ies)[m, i:j];

If this dummy appears in the training set

Get the column index of this dummy, k (i <= k <= j, or k < 0);
If k > 0

Fill a 1 in entry (m,k);

End If
Else

Mark this record invalid;

End If
For k = i:j

x = value of entry (m,k); //1 or 0
Get the mean and norm value for normalization;
$x = \frac{x - mean}{norm} ;$
entry (m,k) = x;

End For

What is claimed is:

1. In a computer-based system, a method of building a statistical model, comprising:
automatically identifying and flagging categorical variables in a data set containing both categorical and continuous variables;
automatically identifying categorical variables that are correlated with one or more continuous variables and eliminating categorical variable that are correlated with at least one continuous variable from a training data matrix used to build a statistical model, wherein the training data matrix comprises a subset of the original data set; and
building the statistical model based on the training data matrix.

2. The method of claim 1 wherein said step of automatically identifying and flagging categorical variables comprises:
determining if a variable contains integer observation values;
if the variable contains integer values, determining the number of unique integer values contained in the variable;
determining if the number of unique values exceeds a predetermined threshold value; and
if the number of unique values does not exceed the threshold value, flagging the variable as a categorical variable.

3. The method of claim 2 further comprising:
if the number of unique values exceeds the threshold value, determining if the variable has predictive strength greater than a predetermined value of Pearson's r;
if the variable has predictive strength greater than the predetermined value of Pearson's r, flagging the variable as a continuous variable;
if the variable has predictive strength less than the predetermined value of Pearson's r, reducing the number of unique values by eliminating those unique values containing less than a predetermined number of entries so as to create a reduced variable set with a reduced number of unique values;
determining if the reduced number of unique values exceeds the threshold value; and
if the reduced number of unique values does not exceed the threshold value, flagging the variable as a categorical variable, else flagging the variable as a continuous variable.

4. The method of claim 1 wherein said step of automatically identifying categorical variables that are highly correlated with one or more continuous variables comprises:
binning at least one continuous variable so as to convert the continuous variable into a psuedo-categorical variable; and
calculating a Cramer's V value between at least one categorical variable and the psuedo-categorical variable to obtain an estimated measure of co-linearity between the categorical variable and the continuous variable.

5. The method of claim 1 further comprising:
calculating a correlation value for each variable in the training data matrix with respect to a target variable;
sorting the variables based on their correlation with the target variable; and
retaining a predetermined number of variables having the highest correlation values and eliminating any remaining variables from the training data matrix.

6. The method of claim 1 further comprising:
expanding each categorical variable contained in the training data matrix into a plurality of dummy variables;
measuring a predictive strength for each dummy variable and continuous variable in the training data matrix toward a target variable;
determining if any pair of variables in the set of dummy and continuous variables exhibits a pair-wise correlation greater than a predetermined threshold; and
if a pair of variables exhibits a pair-wise correlation greater than the threshold, eliminating one of the variables in the pair from the training data matrix, wherein the eliminated variable exhibits less predictive strength toward the target variable than the non-eliminated variable in the pair.

7. The method of claim 1 further comprising:
creating a plurality of principle components from the variables contained in the training data matrix, wherein each principle component comprises a linear combination of variables;
sorting the plurality of principle components by how much variance of the training data matrix each component captures;
selecting a subset of the plurality of principle components that captures a variance greater than a predetermined percentage of total variance; and
using the selected principle components to build the statistical model.

8. The method of claim 7 wherein said step of using the selected principle components to build the statistical model comprises:
performing a singular value decomposition (SVD) to generate a loading matrix; and
mapping coefficients calculated for the principle components back to corresponding variables of the training data matrix using the loading matrix.

9. The method of claim 1 further comprising:
performing a singular value decomposition (SVD) analysis using the variables contained in the training data matrix if the number of records in the training data matrix is less than a predetermined value; and
otherwise, performing a conjugate gradient descent (CGD) analysis on a residual sum of squares based on the variables contained in the training data matrix if the number of records in the training data matrix is greater than or equal to the predetermined value.

10. The method of claim 1 further comprising:
detecting outlier values in the data set; and
for each detected outlier value, presenting a user with the following three options for handling the outlier value: (1) substitute the outlier value with a maximum or minimum non-outlier value in the data set; (2) keep the outlier value in the data set; (3) delete the record corresponding to the outlier value.

11. The method of claim 1 further comprising:
detecting missing values in the data set; and
for each missing value of a variable, inserting a mean value of non-missing values of the variable in place of the missing value in the data set.

12. The method of claim 1 further comprising:
automatically detecting continuous variables having an exponential distribution; and
log-scaling those continuous variables using the following formula:
$$bx ( i ) = 1 - {ⅇ}^{- \frac{x ( i ) - min}{mean - min}} ,$$
where x(i) is a continuous variable being analyzed, min, and mean is the minimum value and the mean value of the variable in samples, respectively.

13. The method of claim 12 further comprising normalizing all the variables in the training data matrix.

14. The method of claim 1 further comprising randomly splitting the data set into a subset of training variables and a subset of test variables, wherein the training variables are used to create the training data matrix for building the model and the subset of test variables are subsequently used to test the resulting model.

15. The method of claim 14 wherein prior to using the subset of test variables to test the model, pre-processing is performed on variables in the test set so as to create a test data matrix containing the same variables and same format as the training data matrix.

16. In a computer-based system, a method of building a statistical model, comprising:
automatically identifying and flagging categorical variables in a data set containing both categorical and continuous variables, wherein this step comprises:
determining if a variable contains integer observation values;
if the variable contains integer values, determining the number of unique integer values contained in the variable;
determining if the number of unique values exceeds a predetermined threshold value; and
if the number of unique values does not exceed the threshold value, flagging the variable as a categorical variable;
automatically identifying categorical variables that are correlated with one or more continuous variables and eliminating categorical variables that are correlated with at least one continuous variable from a training data matrix used to build a statistical model, wherein the training data matrix comprises a subset of the original data set; and
building the statistical model based on the training data matrix.

17. The method of claim 16 further comprising:
if the number of unique values exceeds the threshold value, determining if the variable has predictive strength greater than a predetermined value of Pearson's r;
if the variable has predictive strength greater than the predetermined value of Pearson's r, flagging the variable as a continuous variable;
if the variable has predictive strength less than the predetermined value of Pearson's r, reducing the number of unique values by eliminating those unique values containing less than a predetermined number of entries so as to create a reduced variable set with a reduced number of unique values;
determining if the reduced number of unique values exceeds the threshold value; and
if the reduced number of unique values does not exceed the threshold value, flagging the variable as a categorical variable, else flagging the variable as a continuous variable.

18. The method of claim 16 further comprising:
creating a plurality of principle components from the variables contained in the training data matrix, wherein each principle component comprises a linear combination of variables;
sorting the plurality of principle components by how much variance of the training data matrix each component captures;
selecting a subset of the plurality of principle components that captures a variance greater than a predetermined percentage of total variance; and
using the selected principle components to build the statistical model.

19. The method of claim 18 wherein said step of using the selected principle components to build the statistical model comprises:
performing a singular value decomposition (SVD) to generate a loading matrix; and
mapping coefficients calculated for the principle components back to corresponding variables of the training data matrix using the loading matrix.

20. The method of claim 18 further comprising:
performing a singular value decomposition (SVD) analysis using the variables contained in the training data matrix if the number of records in the training data matrix is less than a predetermined value; and
otherwise, performing a conjugate gradient descent (CGD) analysis on a residual sum of squares based on the variables contained in the training data matrix if the number of records in the training data matrix is greater than or equal to the predetermined value.

21. The method of claim 16 further comprising:
automatically detecting continuous variables having an exponential distribution; and
log-scaling those continuous variables using the following formula:
$$bx ( i ) = 1 - {ⅇ}^{- \frac{x ( i ) - min}{mean - min}} ,$$
where x(i) is a continuous variable being analyzed, min, and mean is the minimum value and the mean value of the variable in samples, respectively.

22. In a computer-based system, a method of building a statistical model, comprising:
automatically identifying and flagging categorical variables in a data set containing both categorical and continuous variables;
binning at least one continuous variable so as to convert the continuous variable into a psuedo-categorical variable;
calculating a Cramer's V value between at least one categorical variable and the psuedo-categorical variable to obtain an estimated measure of co-linearity between the categorical variable and the continuous variable;
based on the calculated Cramer's V value, eliminating a corresponding categorical variable that is correlated with at least one continuous variable from a training data matrix used to build a statistical model, wherein the training data matrix comprises a subset of the original data set; and
building the statistical model based on the training data matrix.

23. The method of claim 22 further comprising:
calculating a correlation value for each variable in the training data matrix with respect to a target variable;
sorting the variables based on their correlation with the target variable; and
retaining a predetermined number of variables having the highest correlation values and eliminating any remaining variables from the training data matrix.

24. The method of claim 22 further comprising:
expanding each categorical variable contained in the training data matrix into a plurality of dummy variables;
measuring a predictive strength for each dummy variable and continuous variable in the training data matrix toward a target variable;
determining if any pair of variables in the set of dummy and continuous variables exhibits a pair-wise correlation greater than a predetermined threshold; and
if a pair of variables exhibits a pair-wise correlation greater than the threshold, eliminating one of the variables in the pair from the training data matrix, wherein the eliminated variable exhibits less predictive strength toward the target variable than the non-eliminated variable in the pair.

25. The method of claim 22 further comprising:
creating a plurality of principle components from the variables contained in the training data matrix, wherein each principle component comprises a linear combination of two or more variables;
sorting the plurality of principle components by how much variance of the training data matrix each component captures;
selecting a subset of the plurality of principle components that captures a variance greater than a predetermined percentage of total variance; and
using the selected principle components to build the statistical model.

26. The method of claim 25 wherein said step of using the selected principle components to build the statistical model comprises:
performing a singular value decomposition (SVD) to generate a loading matrix; and
mapping coefficients calculated for the principle components back to corresponding variables of the training data matrix using the loading matrix.

27. The method of claim 25 further comprising:
performing a singular value decomposition (SVD) analysis using the variables contained in the training data matrix if the number of records in the training data matrix is less than a predetermined value; and
otherwise, performing a conjugate gradient descent (CGD) analysis on a residual sum of squares based on the variables contained in the training data matrix if the number of records in the training data matrix is greater than or equal to the predetermined value.

28. The method of claim 22 further comprising:
automatically detecting continuous variables having an exponential distribution; and
log-scaling those continuous variables using the following formula:
$$bx ( i ) = 1 - {ⅇ}^{- \frac{x ( i ) - min}{mean - min}} ,$$
where x(i) is a continuous variable being analyzed, min, and mean is the minimum value and the mean value of the variable in samples, respectively.

29. A computer-readable medium containing code executable by a computer that when executed performs a process of automatically building a statistical model, said process comprising:
automatically identifying and flagging categorical variables in a data set containing both categorical and continuous variables;
automatically identifying categorical variables that are correlated with one or more continuous variables and eliminating categorical variables that are correlated with at least one continuous variable from a training data matrix used to build a statistical model, wherein the training data matrix comprises a subset of the original data set; and
building the statistical model based on the training data matrix.

30. The computer-readable medium of claim 29 wherein said step of automatically identifying and flagging categorical variables comprises:
determining if a variable contains integer observation values;
if the variable contains integer values, determining the number of unique integer values contained in the variable;
determining if the number of unique values exceeds a predetermined threshold value; and
if the number of unique values does not exceed the threshold value, flagging the variable as a categorical variable.

31. The computer-readable medium of claim 30 wherein said process further comprises:
if the number of unique values exceeds the threshold value, determining if the variable has predictive strength greater than a predetermined value of Pearson's r;
if the variable has predictive strength greater than the predetermined value of Pearson's r, flagging the variable as a continuous variable;
if the variable has predictive strength less than the predetermined value of Pearson's r, reducing the number of unique values by eliminating those unique values containing less than a predetermined number of entries so as to create a reduced variable set with a reduced number of unique values;
determining if the reduced number of unique values exceeds the threshold value; and
if the reduced number of unique values does not exceed the threshold value, flagging the variable as a categorical variable, else flagging the variable as a continuous variable.

32. The computer-readable medium of claim 29 wherein said step of automatically identifying categorical variables that are highly correlated with one or more continuous variables comprises:
binning at least one continuous variable so as to convert the continuous variable into a psuedo-categorical variable; and
calculating a Cramer's V value between at least one categorical variable and the psuedo-categorical variable to obtain an estimated measure of co-linearity between the categorical variable and the continuous variable.

33. The computer-readable medium of claim 29 wherein said process further comprises:
calculating a correlation value for each variable in the training data matrix with respect to a target variable;
sorting the variables based on their correlation with the target variable; and
retaining a predetermined number of variables having the highest correlation values and eliminating any remaining variables from the training data matrix.

34. The computer-readable medium of claim 29 wherein said process further comprises:
expanding each categorical variable contained in the training data matrix into a plurality of dummy variables;
measuring a predictive strength for each dummy variable and continuous variable in the training data matrix toward a target variable;
determining if any pair of variables in the set of dummy and continuous variables exhibits a pair-wise correlation greater than a predetermined threshold; and
if a pair of variables exhibits a pair-wise correlation greater than the threshold, eliminating one of the variables in the pair from the training data matrix, wherein the eliminated variable exhibits less predictive strength toward the target variable than the non-eliminated variable in the pair.

35. The computer-readable medium of claim 29 wherein said process further comprises:
creating a plurality of principle components from the variables contained in the training data matrix, wherein each principle component comprises a linear combination of variables;
sorting the plurality of principle components by how much variance of the training data matrix each component captures;
selecting a subset of the plurality of principle components that captures a variance greater than a predetermined percentage of total variance; and
using the selected principle components to build the statistical model.

36. The computer-readable medium of claim 35 wherein said step of using the selected principle components to build the statistical model comprises:
performing a singular value decomposition (SVD) to generate a loading matrix; and
mapping coefficients calculated for the principle components back to corresponding variables of the training data matrix using the loading matrix.

37. The computer-readable medium of claim 35 wherein said process further comprises:
performing a singular value decomposition (SVD) analysis using the variables contained in the training data matrix if the number of records in the training data matrix is less than a predetermined value; and
otherwise, performing a conjugate gradient descent (CGD) analysis on a residual sum of squares based on the variables contained in the training data matrix if the number of records in the training data matrix is greater than or equal to the predetermined value.

38. The computer-readable medium of claim 29 wherein said process further comprises:
detecting outlier values in the data set; and
for each detected outlier value, presenting a user with the following three options for handling the outlier value: (1) substitute the outlier value with a maximum or minimum non-outlier value in the data set; (2) keep the outlier value in the data set; (3) delete the record corresponding to the outlier value.

39. The computer-readable medium of claim 29 wherein said process further comprises:
detecting missing values in the data set; and
for each missing value of a variable, inserting a mean value of non-missing values of the variable in place of the missing value in the data set.

40. The computer-readable medium of claim 29 wherein said process further comprises:
automatically detecting continuous variables having an exponential distribution; and
log-scaling those continuous variables using the following formula:
$$bx ( i ) = 1 - {ⅇ}^{- \frac{x ( i ) - min}{mean - min}} ,$$
where x(i) is a continuous variable being analyzed, min, and mean is the minimum value and the mean value of the variable in samples, respectively.

41. The computer-readable medium of claim 40 wherein said process further comprises normalizing all the variables in the training data matrix.

42. The computer-readable medium of claim 29 wherein said process further comprises randomly splitting the data set into a subset of training variables and a subset of test variables, wherein the training variables are used to create the training data matrix for building the model and the subset of test variables are subsequently used to test the resulting model.

43. The computer-readable medium of claim 42 wherein prior to using the subset of test variables to test the model, pre-processing is performed on variables in the test set so as to create a test data matrix containing the same variables and same format as the training data matrix.

44. A computer-readable medium containing code executable by a computer that when executed performs a process of automatically building a statistical model, the process comprising:
automatically identifying and flagging categorical variables in a data set containing both categorical and continuous variables, wherein this step comprises:
determining if a variable contains integer observation values;
if the variable contains integer values, determining the number of unique integer values contained in the variable;
determining if the number of unique values exceeds a predetermined threshold value; and
if the number of unique values does not exceed the threshold value, flagging the variable as a categorical variable;
automatically identifying categorical variables that are correlated with one or more continuous variables and eliminating categorical variables that are correlated with at least one continuous variable from a training data matrix used to build a statistical model, wherein the training data matrix comprises a subset of the original data set; and
building the statistical model based on the training data matrix.

45. The computer-readable medium of claim 44 wherein said process further comprises:
if the number of unique values exceeds the threshold value, determining if the variable has predictive strength greater than a predetermined value of Pearson's r;
if the variable has predictive strength greater than the predetermined value of Pearson's r, flagging the variable as a continuous variable;
if the variable has predictive strength less than the predetermined value of Pearson's r, reducing the number of unique values by eliminating those unique values containing less than a predetermined number of entries so as to create a reduced variable set with a reduced number of unique values;
determining if the reduced number of unique values exceeds the threshold value; and
if the reduced number of unique values does not exceed the threshold value, flagging the variable as a categorical variable, else flagging the variable as a continuous variable.

46. The computer-readable medium of claim 44 wherein said process further comprises:
creating a plurality of principle components from the variables contained in the training data matrix, wherein each principle component comprises a linear combination of variables;
sorting the plurality of principle components by how much variance of the training data matrix each component captures;
selecting a subset of the plurality of principle components that captures a variance greater than a predetermined percentage of total variance; and
using the selected principle components to build the statistical model.

47. The computer-readable medium of claim 46 wherein said step of using the selected principle components to build the statistical model comprises:
performing a singular value decomposition (SVD) to generate a loading matrix; and
mapping coefficients calculated for the principle components back to corresponding variables of the training data matrix using the loading matrix.

48. The computer-readable medium of claim 46 wherein said process further comprises:
performing a singular value decomposition (SVD) analysis using the variables contained in the training data matrix if the number of records in the training data matrix is less than a predetermined value; and
otherwise, performing a conjugate gradient descent (CGD) analysis on a residual sum of squares based on the variables contained in the training data matrix if the number of records in the training data matrix is greater than or equal to the predetermined value.

49. The computer-readable medium of claim 46 wherein said process further comprises:
automatically detecting continuous variables having an exponential distribution; and
log-scaling those continuous variables using the following formula:
$$bx ( i ) = 1 - {ⅇ}^{- \frac{x ( i ) - min}{mean - min}} ,$$
where x(i) is a continuous variable being analyzed, min, and mean is the minimum value and the mean value of the variable in samples, respectively.

50. A computer-readable medium containing code executable by a computer that when executed performs a process of automatically building a statistical model, the process comprising:
automatically identifying and flagging categorical variables in a data set containing both categorical and continuous variables;
binning at least one continuous variable so as to convert the continuous variable into a psuedo-categorical variable;
calculating a Cramer's V value between at least one categorical variable and the psuedo-categorical variable to obtain an estimated measure of co-linearity between the categorical variable and the continuous variable;
based on the calculated Cramer's V value, eliminating a corresponding categorical variable that is correlated with at least one continuous variable from a training data matrix used to build a statistical model, wherein the training data matrix comprises a subset of the original data set; and
building the statistical model based on the training data matrix.

51. The computer-readable medium of claim 50 wherein said process further comprises:
calculating a correlation value for each variable in the training data matrix with respect to a target variable;
sorting the variables based on their correlation with the target variable; and
retaining a predetermined number of variables having the highest correlation values and eliminating any remaining variables from the training data matrix.

52. The computer-readable medium of claim 50 wherein said process further comprises:
expanding each categorical variable contained in the training data matrix into a plurality of dummy variables;
measuring a predictive strength for each dummy variable and continuous variable in the training data matrix toward a target variable;
determining if any pair of variables in the set of dummy and continuous variables exhibits a pair-wise correlation greater than a predetermined threshold; and
if a pair of variables exhibits a pair-wise correlation greater than the threshold, eliminating one of the variables in the pair from the training data matrix, wherein the eliminated variable exhibits less predictive strength toward the target variable than the non-eliminated variable in the pair.

53. The computer-readable medium of claim 50 wherein said process further comprises:
creating a plurality of principle components from the variables contained in the training data matrix, wherein each principle component comprises a linear combination of variables;
sorting the plurality of principle components by how much variance of the training data matrix each component captures;
selecting a subset of the plurality of principle components that captures a variance greater than a predetermined percentage of total variance; and
using the selected principle components to build the statistical model.

54. The computer-readable medium of claim 53 wherein said step of using the selected principle components to build the statistical model comprises:
performing a singular value decomposition (SVD) to generate a loading matrix; and
mapping coefficients calculated for the principle components back to corresponding variables of the training data matrix using the loading matrix.

55. The computer-readable medium of claim 53 further comprising:
performing a singular value decomposition (SVD) analysis using the variables contained in the training data matrix if the number of records in the training data matrix is less than a predetermined value; and
otherwise, performing a conjugate gradient descent (CGD) analysis on a residual sum of squares based on the variables contained in the training data matrix if the number of records in the training data matrix is greater than or equal to the predetermined value.

56. The computer-readable medium of claim 50 further comprising:
automatically detecting continuous variables having an exponential distribution; and
log-scaling those continuous variables using the following formula:
$$bx ( i ) = 1 - {ⅇ}^{- \frac{x ( i ) - min}{mean - min}} ,$$
where x(i) is a continuous variable being analyzed, min, and mean is the minimum value and the mean value of the variable in samples, respectively.
